(19) United States
(12) Patent Application Publication
(10) Pub. No.: US 2008/0291528 A1
(43) Pub. Date: Nov. 27, 2008

(54) WAVELENGTH CONVERTER SYSTEM, CRYSTAL STORAGE APPARATUS, AND CRYSTAL REPLACEMENT METHOD OF WAVELENGTH CONVERTER

(75) Inventor: Iida SUSUMU, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Advanced Mask Inspection Technology, Inc., Yokohama-shi (JP)

(21) Appl. No.: 12/124,714

(22) Filed: May 21, 2008

(30) Foreign Application Priority Data
May 23, 2007 (JP) 2007-136095

(51) Int. Cl. G02F 1/35

(52) U.S. Cl. 359/326

(57) ABSTRACT

A wavelength converter system capable of replacing a nonlinear crystal in a wavelength converter in a short time with ease is provided. The wavelength converter system includes the wavelength converter for converting a wavelength by passing light through the nonlinear crystal and a crystal storage apparatus for storing a nonlinear crystal for replacement used by the wavelength converter, wherein the wavelength converter has a first crystal holder for fixing the nonlinear crystal and a first heater for heating the nonlinear crystal and the crystal storage apparatus has a container, a second crystal holder that is in the container to fix the nonlinear crystal for replacement and interchangeable with the first crystal holder, and a second heater for heating the nonlinear crystal for replacement.

### CROSS-REFERENCE TO RELATED APPLICATION

This application is based upon and claims the benefit of priority from Japanese Patent Applications No. 2007-136095, filed on May 23, 2007, the entire contents of which are incorporated herein by reference.

### FIELD OF THE INVENTION

The present invention relates to a wavelength converter system, a crystal storage apparatus, and a crystal replacement method of a wavelength converter.

### BACKGROUND OF THE INVENTION

A laser light, which is a coherent light, generally has a higher frequency than a radio wave and thus, larger information holding capacity. The laser light also has single wavelength and equal phase and thus, displays excellent monochromaticity and directivity with coherence, which is not observed in normal rays. Further, the laser light can be converged extremely thinly and therefore, high temperature and high pressure can be realized locally and customarily by concentrating energy on a microscopic area. Since the laser light has these properties, it has found wide application such as application to communication and information technology, measuring instruments, processing technology, and medical fields.

Among laser lights used for various applications described above, a laser light in a deep ultraviolet region is used for applications requiring particularly short wavelengths. However, limited laser media and excitation sources in the deep ultraviolet region, make laser oscillation difficult. Thus, many laser sources in the deep ultraviolet region use methods by which wavelengths of laser output from relatively stable near infrared to visible regions are converted. That is, these laser sources use a wavelength converter utilizing higher harmonics generation or sum frequency generation using a nonlinear crystal (or a nonlinear optical crystal) (for example, JP-A 2004-55695 (KOKAI) and JP-A 2004-220051 (KOKAI)).

When higher harmonics generation is utilized, laser output of integral multiples of frequency such as 2ω and 3ω can be obtained by inputting a laser light of a frequency ω into a nonlinear crystal. That is, laser output whose wavelength is shortened to λ/2 and λ/3 with respect to the input wavelength λ can be obtained. When sum frequency generation is utilized, laser output of the frequency ω3 (=ω1+ω2) can be obtained by passing laser light of two different frequencies ω1 and ω2 through a nonlinear crystal. That is, laser output of a wavelength λ3, which satisfies a relationship 1/λ3=1/λ1+1/λ2 with respect to input wavelengths λ1 and λ2 and is shorter than any of the input wavelengths λ1 and λ2, can be obtained.

Generally, output performance of a nonlinear crystal greatly depends on the ambient temperature of the crystal. Therefore, if used in a temperature environment in which the temperature changes considerably due to an external environment such as a room temperature, output performance such as output intensity, an emission direction, and beam patterns of an output light fluctuates significantly. Thus, the nonlinear crystal is usually used in a high-temperature environment of about 100 to 200° C. in which the width of temperature change can be made smaller. Another reason the nonlinear crystal is usually used in a high-temperature environment of about 100 to 200° C. is most of nonlinear crystals used for wavelength conversion have phase matching temperature in that temperature range.

A nonlinear crystal in a wavelength converter is thermally degraded by a high-energy coherent light on the surface thereof and therein. Output performance is degraded by the degradation in crystal quality. Thus, though dependent on the mode of utilization, the crystal should be replaced once every several months or so.

When replacing a nonlinear crystal, the temperature of the crystal maintained at a high temperature must be caused to fall to a room temperature to replace the crystal with a new one before being raised to a high-temperature environment again. At this time, there is a possibility of the crystal being broken or cracked by expansion or contraction caused by a rapid temperature change. Thus, the temperature should be raised with a gradient of 1 to 2° C./min or so. Therefore, when replacing a crystal, a down time (standby time) due to a temperature rise will occur.

Further, the installation angle of a crystal is highly sensitive to conditions of higher harmonics generation or sum frequency generation. If, for example, the installation angle of a new crystal is significantly shifted from that before crystal replacement, a lot more time will be needed for adjusting the installation angle of crystal and optical axes such as positions of mirrors or lenses inside a resonator. Thus, a nonlinear crystal should be installed with caution and discretion during crystal replacement and thus, a longer work time will be needed, thereby creating a down time therefor.

Generally, as described above, in addition to requiring a down time of half a day to several days for a temperature rise and crystal position adjustments, replacement work itself will be on a large scale. JP-A 2005-286214 (KOKAI) discloses a crystal holder for making position adjustments for replacement of a nonlinear crystal easier.

### SUMMARY OF THE INVENTION

A wavelength converter system in accordance with an aspect of the present invention is a wavelength converter system having a wavelength converter for converting a wavelength by passing light through a nonlinear crystal and a crystal storage apparatus for storing a nonlinear crystal for replacement used by the wavelength converter. The wavelength converter includes a first crystal holder for fixing the nonlinear crystal and a first heater mounted on the first crystal holder to heat the nonlinear crystal. The crystal storage apparatus includes a container, a second crystal holder provided inside the container to fix the nonlinear crystal for replacement and interchangeable with the first crystal holder, and a second heater mounted on the second crystal holder to heat the nonlinear crystal for replacement.

A crystal storage apparatus in accordance with an aspect of the present invention is a crystal storage apparatus for storing a nonlinear crystal for replacement used by a wavelength converter for converting a wavelength by passing light through a nonlinear crystal. The crystal storage apparatus includes a container, a crystal holder provided inside the container to fix the nonlinear crystal for replacement and mountable on the wavelength converter, and a heater mounted on the crystal holder to heat the nonlinear crystal for replacement.

A crystal replacement method of a wavelength converter in accordance with an aspect of the present invention is a crystal replacement method of a wavelength converter using a crystal storage apparatus for storing a nonlinear crystal for replacement used by the wavelength converter. The nonlinear crystal for replacement is heated to a predetermined temperature in advance by the crystal storage apparatus, a nonlinear crystal to be replaced in the wavelength converter is removed, and the nonlinear crystal for replacement is mounted on the wavelength converter while maintaining the predetermined temperature.

A crystal replacement method of a wavelength converter in accordance with an aspect of the present invention is a crystal replacement method of a wavelength converter using a crystal storage apparatus for storing a nonlinear crystal for replacement used by the wavelength converter. A nonlinear crystal fixed to a first crystal holder of the wavelength converter is maintained at a predetermined temperature by supplying power to a first heater mounted on the first crystal holder from a first power supply system, a nonlinear crystal for replacement fixed to a second crystal holder of the crystal storage apparatus is maintained at the predetermined temperature by supplying power to a second heater mounted on the second crystal holder from a second power supply system, the first crystal holder of the wavelength converter is removed from the wavelength converter, the second crystal holder is mounted on the wavelength converter in place of the first crystal holder while power from the second power supply system to the second heater is being supplied, and a power supply source to the second heater is switched from the second power supply system to the first power supply system.

According to the present invention, a wavelength converter system, a crystal storage apparatus, and a crystal replacement method of a wavelength converter capable of replacing a nonlinear crystal in the wavelength converter in a short time with ease can be provided.

### BRIEF DESCRIPTION OF THE DRAWINGS

FIG. 1 is a sectional view of a wavelength converter system according to a first embodiment.

FIG. 2 to FIG. 5 are explanatory diagrams of a crystal replacement method according to the first embodiment.

FIG. 6 is a sectional view of a wavelength converter system according to a second embodiment.

FIG. 7 is an explanatory diagram of a crystal replacement method according to the second embodiment.

FIG. 8 and FIG. 9 are sectional views of a wavelength converter system according to a third embodiment.

### DETAILED DESCRIPTION OF THE EMBODIMENTS

Embodiments of a wavelength converter system, a crystal storage apparatus, and a crystal replacement method of a wavelength converter according to the present invention will be described below with reference to drawings.

### First Embodiment

A wavelength converter system according to the first embodiment of the present invention includes a wavelength converter for converting the wavelength by passing light through a nonlinear crystal and a crystal storage apparatus for storing a nonlinear crystal for replacement used for the wavelength converter. The wavelength converter has a first crystal holder for fixing the nonlinear crystal and a first heater mounted on the first crystal holder to heat the nonlinear crystal. Further, the crystal storage apparatus has a container, a second crystal holder provided inside the container to fix the nonlinear crystal for replacement and interchangeable with the first crystal holder, and a second heater mounted on the second crystal holder to heat the nonlinear crystal for replacement.

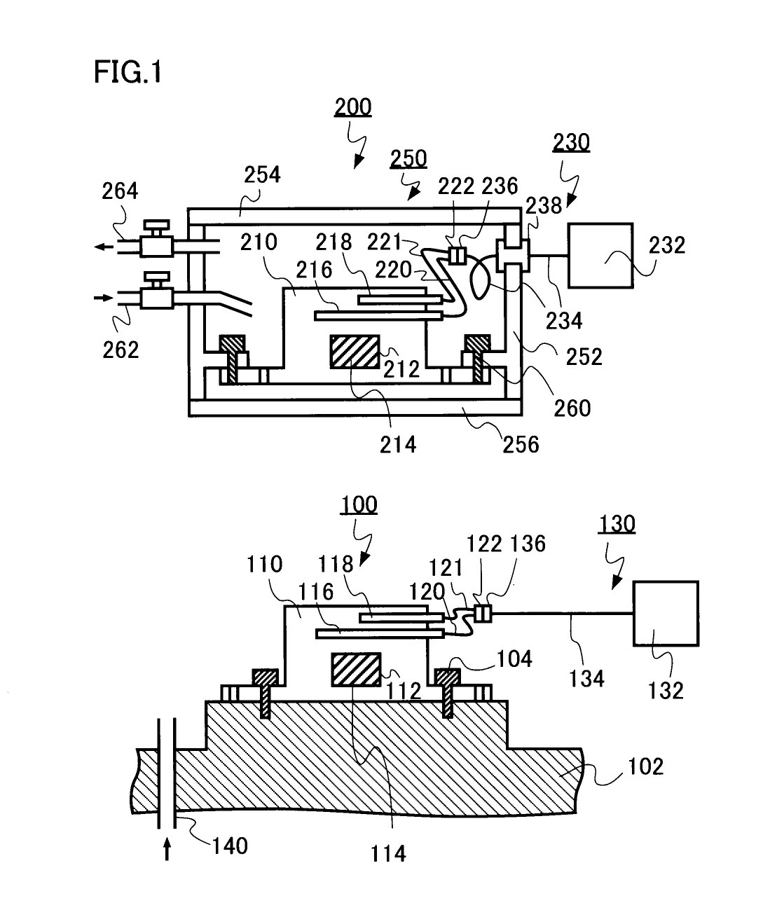

FIG. 1 is a sectional view of a wavelength converter system according to the present embodiment. The wavelength converter system includes a wavelength converter 100 and a crystal storage apparatus 200. Here, the wavelength converter 100 uses, for example, lithium borate (LiB₃O₅, hereinafter also called a LBO crystal) as a nonlinear crystal. The LBO crystal converts an Nd-YAG laser light into a laser light of the wavelength 532 nm by sum frequency generation (second harmonic generation). Thus, the wavelength converter 100 in the present embodiment has a configuration and a function to convert the wavelength of light, for example, a laser light of the wavelength of 1064 nm into a light of the wavelength of 532 nm by being passed through a nonlinear crystal, for example, an LBO crystal.

In the wavelength converter 100, a first crystal holder 110 is fixed onto a substrate 102 by a fixture 104 such as a screw. A nonlinear crystal 114, which is an LBO crystal, for example, is fixed to a crystal installation portion 112 of the first crystal holder 110 after both facets thereof being cut and polished to desired wavelength convertible phase matching angles. Here, the crystal installation portion 112 is preferably processed to have roughly the same internal shape as an external shape of the nonlinear crystal 114 so that the nonlinear crystal 114 can always be fixed easily to the same place with respect to the first crystal holder 110. Moreover, a fixture such as a screw to fix the nonlinear crystal 114 to the crystal installation portion may be provided. In FIG. 1, an input light before wavelength conversion is incident on the nonlinear crystal 114 from your side and an output light whose wavelength has been converted is emitted toward the other side.

The first crystal holder 110 also has a first heater 116 and a temperature monitor 118 to heat and maintain the nonlinear crystal 114 at a predetermined working temperature (phase matching temperature), for example, at 148° C. for an LBO crystal. Here, an electrothermal heater, for example, may be used as the first heater 116. A thermocouple or a resistance bulb, for example, may be used as the temperature monitor 118. A heat-resistant male connector 122 is connected to heat-resistant wires 120 and 121 provided in the first crystal holder 110 and extending from the first heater 116 and the temperature monitor 118.

The wavelength converter 100 has a first power supply system 130 to the first heater 116. The first power supply system 130 includes a first temperature control unit 132, a wire 134 from the first temperature control unit 132, and a heat-resistant female connector 136 at an end of the wire 134. The first temperature control unit 132 is comprised of a power source, a temperature controller and the like.

Here, the heat-resistant male connector 122 of the heat-resistant wire 120 extending from the first heater 116 and the temperature monitor 118 and the heat-resistant female connector 136 at an end of the wire 134 from the first temperature control unit 132 are connected. With both connectors being connected, the nonlinear crystal 114 can be heated and maintained at a predetermined working temperature (phase matching temperature) by supplying power to the first heater 116.

Further, the wavelength converter 100 is preferably provided with a dry gas outlet 140 to feed a dry gas such as an inert gas and dry air to an atmosphere inside the apparatus, particularly that in contact with the nonlinear crystal 114. This is because particularly when the nonlinear crystal 114 having a deliquescent property is used, degradation of the nonlinear crystal 114 can thereby be suppressed, allowing prolonging the working life thereof.

Independently of the wavelength converter 100, the wavelength converter system in the present embodiment includes a crystal storage apparatus 200. The crystal storage apparatus 200 is an apparatus in preparation for a case when the nonlinear crystal 114 used by the wavelength converter 100 reaches its life span. The crystal storage apparatus 200 has a function to heat and store a nonlinear crystal for replacement 214, which is the same type as the nonlinear crystal 114, at a predetermined working temperature (phase matching temperature) so that the nonlinear crystal for replacement 214 can be used by the wavelength converter 100.

The crystal storage apparatus 200 includes a container 250 and a second crystal holder 210 provided inside the container 250 to fix the nonlinear crystal for replacement 214. Here, the external shape of the container 250 is formed of a main body 252, a top cover 254, and a base lid 256. The container 250 includes a fixture 260 such as a screw to fix the second crystal holder 210 to the main body 252.

The second crystal holder 210 is interchangeable with the first crystal holder 110 of the wavelength converter 100. That is, the second crystal holder 210 has the same shape as that of the first crystal holder 110 and is configured in such a way that, after being removed from the container 250, like the first crystal holder 110, the second crystal holder 210 can be fixed to the substrate 102 of the wavelength converter 100 by the fixture 104 such as a screw.

Moreover, like the first crystal holder 110, the nonlinear crystal for replacement 214 is fixed to a crystal installation portion 212 of the second crystal holder 210 after both facets thereof being cut and polished to desired wavelength convertible phase matching angles. Here, the crystal installation portion 212 is preferably processed to have roughly the same internal shape as an external shape of the nonlinear crystal for replacement 214 so that the nonlinear crystal for replacement 214 can always be fixed easily to the same place with respect to the second crystal holder 210. Moreover, a fixture such as a screw to fix the nonlinear crystal for replacement 214 to the crystal installation portion may be provided.

The second crystal holder 210 also has a second heater 216 and a temperature monitor 218 to heat and maintain the nonlinear optical crystal for replacement 214 at a predetermined working temperature (phase matching temperature), for example, at 148° C. for an LBO crystal. Here, an electrothermal heater, for example, may be used as the second heater 216 and a thermocouple, for example, may be used as the temperature monitor 218. A heat-resistant male connector 222 is connected to heat-resistant wires 220 and 221 provided in the second crystal holder 210 and extending from the second heater 216 and the temperature monitor 218.

The crystal storage apparatus 200 has a second power supply system 230 to the second heater 216. The second power supply system 230 includes a second temperature control unit 232, a wire 234 from the second temperature control unit 232, and a heat-resistant female connector 236 at an end of the wire 234. The second temperature control unit 232 is comprised of a power source, a temperature controller and the like. Also, an airtight connector 238 for electrically connecting the wire 234 from outside into the container is provided in the main body 252 of the container 250.

The heat-resistant male connector 222 of the heat-resistant wires 220 and 221 extending from the second heater 216 and the temperature monitor 218 and the heat-resistant female connector 236 at an end of the wire 234 from the second temperature control unit 232 are connected. With both connectors being connected, the nonlinear optical crystal for replacement 214 can be heated and maintained at a predetermined working temperature (phase matching temperature), which is the same as that of the nonlinear crystal 114, by supplying power to the second heater 216.

Further, the crystal storage apparatus 200 is preferably provided, as shown in FIG. 1, with a gas inlet 262 for feeding at least one gas, for example, an insert gas or dry air into the container 250 and a gas outlet 264 for discharging the gas. This is because particularly when the nonlinear crystal for replacement 214 having a deliquescent property is used, degradation of the nonlinear crystal for replacement 214 can thereby be suppressed during storage. The gas inlet 262 and the gas outlet 264 each have a valve for blocking the flow of gas provided therein.

In the present embodiment, the main body 252, the top cover 254, the base lid 256, and the airtight connector 238 are constructed to maintain airtightness by an airtight seal, screwing and the like. However, when a nonlinear crystal having no deliquescent property is used, for example, high airtightness inside the container 250 is not necessarily demanded.

When replacing the first crystal holder 110 with the second crystal holder 210, it is preferable to have a gas blowing device for blowing a gas to the nonlinear crystal for replacement 214 from the gas inlet 262. This is because degradation due to a deliquescent property can be suppressed when the nonlinear crystal for replacement 214 is exposed to air during replacement. The gas blowing device becomes realizable, for example, by using a flexible pipe between the gas inlet 262 and a gas line or a gas cylinder (not shown) for feeding a gas.

Next, a crystal replacement method using a wavelength converter system in the present embodiment will be described using FIG. 1 to FIG. 5. First, as shown in FIG. 1, the nonlinear crystal for replacement 214, which is the same type as the nonlinear crystal 114, is fixed to the crystal installation portion 212 of the second crystal holder 210 in the crystal storage apparatus 200 before the nonlinear crystal 114 used in the wavelength converter 100 becomes unusable due to degradation. Here, since the crystal installation portion 212 is processed to have roughly the same internal shape as an external shape of the nonlinear crystal for replacement 214 so that the nonlinear crystal for replacement 214 can be fixed in a state similar to an actually utilized state with respect to the second crystal holder 210. Since the time for fixing and adjustments therefor is independent of a down time of the wavelength converter 100, replacement can be made with caution and discretion taking a lot of time therefor.

When a crystal having a deliquescent property is used as the nonlinear crystal for replacement 214, it is preferable to fix and adjust the crystal while blowing a gas for drying such as a nitrogen gas to the nonlinear crystal for replacement 214 from the gas inlet 262. This is because degradation of the nonlinear crystal for replacement 214 being fixed and adjusted can thereby be suppressed by removing moisture in the atmosphere.

Next, after fixing of the nonlinear crystal for replacement 214 to the second crystal holder 210 and adjustments thereof are completed, the nonlinear crystal for replacement 214 is heated in advance by an electrothermal heater, which is the second heater 216, and the temperature monitor 218 to a predetermined temperature in the crystal storage apparatus 200. The predetermined temperature in this case is a temperature near an actually utilized temperature of the nonlinear crystal 114 of the wavelength converter 100 and, for example, a temperature near 148° C. for an LBO crystal. If the nonlinear crystal for replacement 214 has a deliquescent property, it is preferable to always introduce a gas for drying such as a nitrogen gas from the gas inlet 262 and also to exhaust air from the gas outlet 264 to prevent degradation of the nonlinear crystal for replacement 214 by maintaining moisture content in the atmosphere inside the container 250 at a low level.

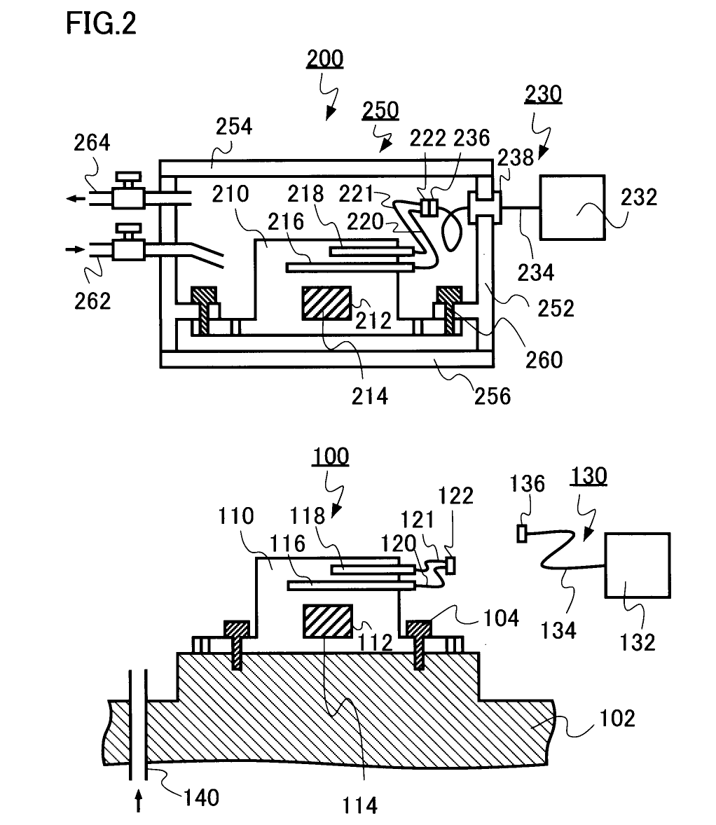

Next, if the nonlinear crystal 114 used in the wavelength converter 100 degrades and replacement thereof is needed, incidence of the laser light is first stopped. Then, as shown in FIG. 2, the female connector 136 connected to the first temperature control unit 132 and the male connector 122 connected to the first heater 116 and the temperature monitor 118 are disconnected. At this time, a feedback circuit of the first temperature control unit 132 must be adjusted so that the supply of power from a power source of the first temperature control unit 132 should not run away. Subsequently, the first crystal holder 110 and the wavelength converter 100 are completely separated by removing the fixture 104 such as a screw fixing the first crystal holder 110 to the substrate 102 of the wavelength converter 100.

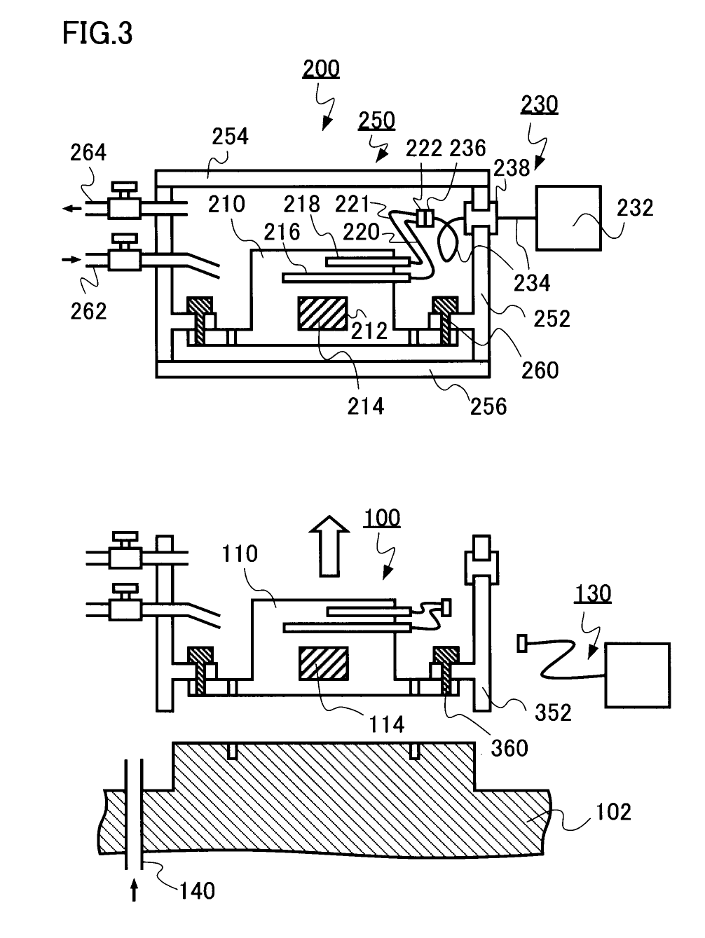

FIG. 3 shows a method of removing the first crystal holder 110 by using a standby main body 352 of the wavelength converter 100. This method is particularly effective as a method of safely removing the first crystal holder 110 when the first crystal holder 110 is not cool enough, for example, immediately after separating the first crystal holder 110 from the first temperature control unit 132. In this case, the standby main body 352 is put over the first crystal holder 110 and then the standby main body 352 is fixed to the first crystal holder 110 using a fixture 360 such as a screw. Subsequently, the first crystal holder 110 can completely be removed from the wavelength converter 100 by lifting the standby main body 352 upward. If the temperature of the first crystal holder is sufficiently low, the first crystal holder 110 may directly be removed using, for example, heat-resistant gloves.

Next, a method of mounting the nonlinear crystal for replacement 214 stored in the crystal storage apparatus 200 on the wavelength converter 100 will be described. First, the crystal storage apparatus 200 is moved close to the wavelength converter 100 while maintaining the nonlinear crystal for replacement 214 at a predetermined temperature. Then, the top cover 254 and the base lid 256 fixed by the fixture such as a screw are separated from the main body 252. If, at this time, feeding of a dry gas is continued from the gas inlet 262, degradation due to exposure to the air can be suppressed because the nonlinear crystal for replacement 214 is enclosed in a narrow area by the main body 252. By using a flexible pipe between the gas inlet 262 and a gas line or a gas cylinder (not shown) for feeding a gas, for example, feeding of a gas can be continued while moving the main body 252.

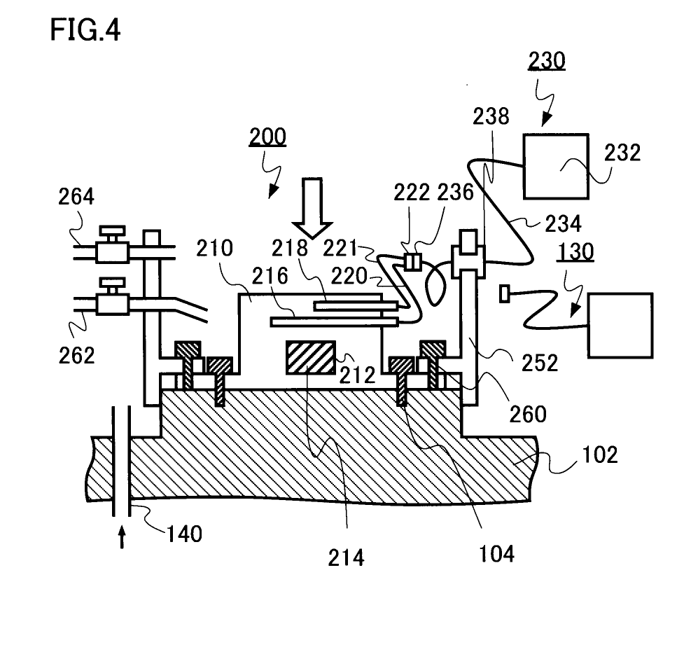

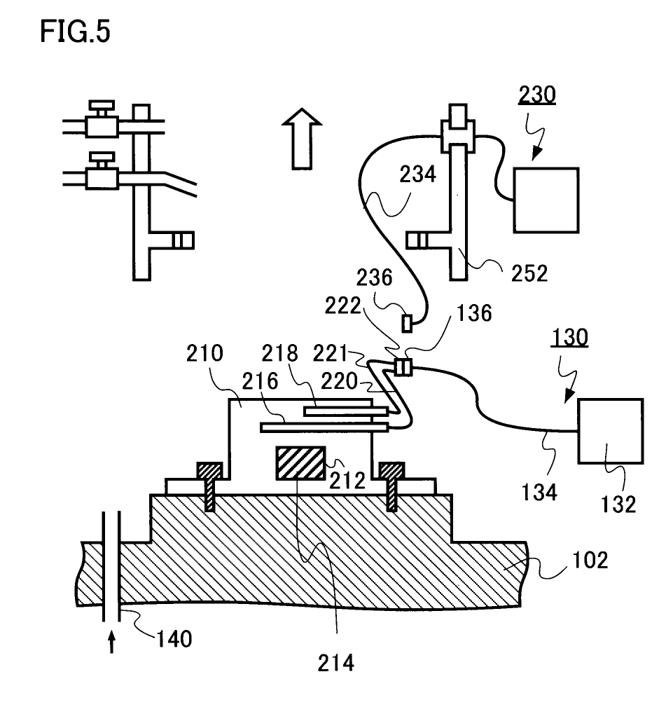

Next, as shown in FIG. 4, the main body 252 is placed on the substrate 102 of the wavelength converter 100, and the second crystal holder 210 and the substrate 102 are fixed by the fixture 104 such as a screw. Then, as shown in FIG. 5, by removing the fixture 260 such as a screw fixing the second crystal holder 210 to the main body 252, the second crystal holder 210 and the main body 252 are separated. Then, when the main body 252 is lifted, a wire 234 folded compactly is extended. Then, the heat-resistant male connector 222 is separated from the heat-resistant female connector 236 and immediately connected to the heat-resistant female connector 136 connected to the first temperature control unit 132. Accordingly, heating by the second heater 216 is continued so that a predetermined temperature is maintained with the temperature of the nonlinear crystal for replacement 214 hardly dropping.

Here, if the nonlinear crystal for replacement 214 has a deliquescent property, it is preferable to feed a dry gas from the dry gas outlet 140 after the main body 252 is lifted. This is because degradation of the nonlinear crystal for replacement 214 can thereby be suppressed.

Incidentally, the position of the nonlinear crystal for replacement 214 with respect to the second crystal holder has been adjusted so as to be just like a spatial relationship between the first crystal holder 110 and the nonlinear crystal 114. Moreover, as described above, the nonlinear crystal for replacement 214 is heated and maintained at a working temperature. Thus, a desired laser light whose wavelength is converted can immediately be obtained by irradiating the nonlinear crystal for replacement 214 with a laser light from a laser light source.

According to the present embodiment, as described above, there is no need to raise the temperature when replacing a nonlinear crystal and therefore, a down time of an apparatus can significantly be reduced. That is, the operating ratio of a wavelength converter is improved, thereby allowing a significant increase in productivity of an apparatus using the wavelength converter. Moreover, a nonlinear crystal is fixed in a state in which the nonlinear crystal is adjusted to a crystal holder, which is interchangeable with a crystal holder of a wavelength converter, in advance. Thus, there is no need to remove a crystal when replacing the crystal and the crystal can be replaced by mechanically connecting the crystal holder and the wavelength converter. Therefore, an adjustment time for crystal optical coefficients such as a phase matching angle can be reduced.

When a nonlinear crystal is stored or replaced, the nonlinear crystal for replacement can be maintained in a dry gas atmosphere by a dry gas fed from a gas inlet provided in a container while the nonlinear crystal is enclosed by a crystal storage apparatus or the container thereof. After being installed in a wavelength converter, the nonlinear crystal for replacement can be maintained in a dry gas atmosphere by a dry gas fed from a dry gas outlet provided in a substrate thereof. Thus, if a nonlinear crystal for replacement has a deliquescent property, degradation of the crystal resulting from crystal replacement work can be suppressed.

Thus, according to the present embodiment, the temperature rise time and crystal position adjustment time during crystal replacement can significantly be reduced when compared with conventional technologies and therefore, an operation effect of being able to significantly reduce a down time of a wavelength converter caused during maintenance of an apparatus is achieved. In addition, an operation effect of being able to suppress crystal degradation even if the crystal has a deliquescent property is achieved.

### Second Embodiment

A wavelength converter system according to the second embodiment of the present invention is the same as that in the first embodiment except that the wavelength converter has a mechanism to continuously switch a power supply source to the second heater from the second power supply system to the first second power supply system and thus, duplicate descriptions will be omitted.

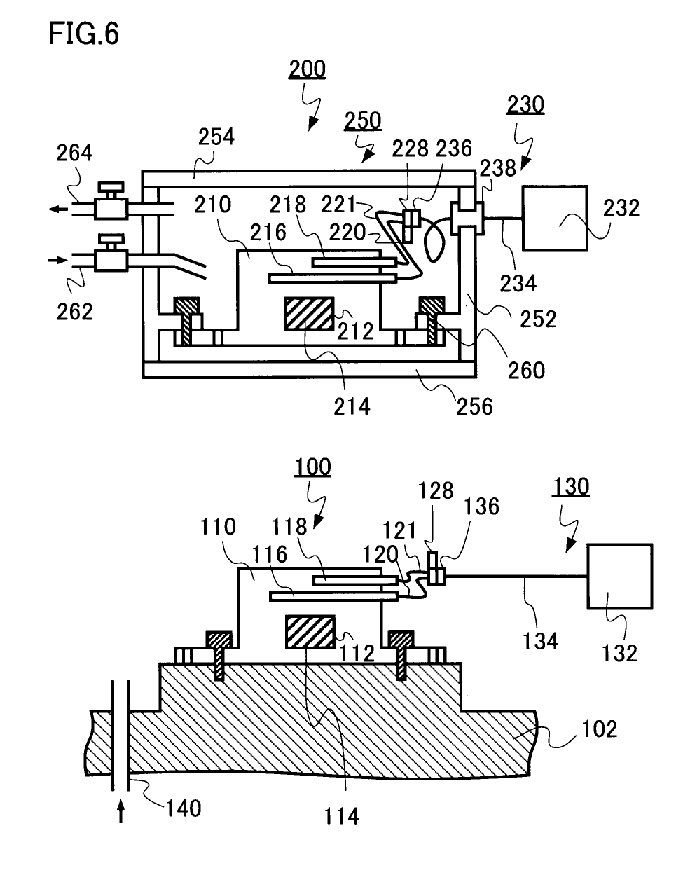

FIG. 6 is a sectional view of a wavelength converter system according to the present embodiment. The wavelength converter system is the same as that in the first embodiment in that the wavelength converter system includes the wavelength converter 100 and the crystal storage apparatus 200. The crystal storage apparatus 200 has a heat-resistant male connector with two connecting terminals 228 as a mechanism to switch the power supply source to the second heater 216 from the second power supply system 230 to the first power supply system 130.

The heat-resistant male connector with two connecting terminals 228 includes two terminals, namely, a first connecting terminal and a second connecting terminal so that two female connectors can simultaneously be connected. The heat-resistant male connector with two connecting terminals 228 also has a changeover switch so that the supply of power from two power supply systems can be switched by operating the changeover switch.

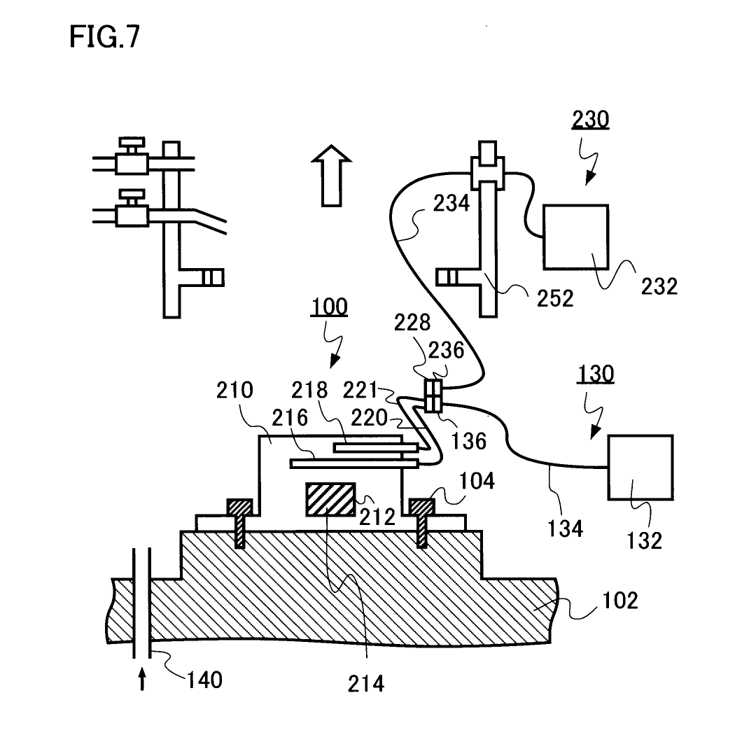

A crystal replacement method using a wavelength converter in the present embodiment will briefly be described with reference to FIG. 6 and FIG. 7. First, as shown in FIG. 6, while the wavelength converter 100 is operating, a heat-resistant male connector with two connecting terminals 128 of the heat-resistant wires 120 and 121 extending from the first heater 116 and the temperature monitor 118 and the heat-resistant female connector 136 at an end of the wire 134 from the first temperature control unit 132 are connected by the first connecting terminal (lower side in the figure) of the heat-resistant male connector with two connecting terminals 128. Power is thereby supplied to the first heater 116 to heat and maintain the nonlinear optical crystal 114 at a predetermined working temperature (phase matching temperature). Then, as shown in FIG. 6, like the first embodiment, the nonlinear crystal for replacement 214, which is the same type as the nonlinear crystal 114, is fixed to the crystal installation portion 212 of the second crystal holder 210 in the crystal storage apparatus 200 before the nonlinear crystal 114 used in the wavelength converter 100 becomes unusable due to degradation.

Next, after fixing of the nonlinear crystal for replacement 214 to the second crystal holder 210 and adjustments thereof are completed, the nonlinear crystal for replacement 214 is heated in advance by an electrothermal heater, which is the second heater 216, and the temperature monitor 218 to a predetermined temperature in the crystal storage apparatus 200. At this time, the heat-resistant female connector 236 of the wire 234 extended for the supply of power or the like from the second temperature control unit 232 of the second power supply system 230 is connected to the second connecting terminal (upper side in the figure) of the heat-resistant male connector with two connecting terminals 228.

Next, if the nonlinear crystal 114 used in the wavelength converter 100 degrades and replacement thereof is needed, incidence of the laser light is first stopped. Then, the heat-resistant female connector 136 connected to the first temperature control unit 132 and the heat-resistant male connector with two connecting terminals 128 connected to the first heater 116 and the temperature monitor 118 are separated. Further, the first crystal holder 110 and the wavelength converter 100 are completely separated, which is the same as the method described in the first embodiment.

Next, a method of mounting the nonlinear crystal for replacement 214 stored in the crystal storage apparatus 200 on the wavelength converter 100 will be described. First, the crystal storage apparatus 200 is moved close to the wavelength converter 100 while maintaining the nonlinear crystal for replacement 214 at a predetermined temperature. Then, the top cover 254 and the base lid 256 fixed by the fixture such as a screw are separated from the main body 252, which is the same method as that in the first embodiment.

Next, as shown in FIG. 7, the main body 252 is placed on the substrate 102 of the wavelength converter 100, and the second crystal holder 210 and the substrate 102 are fixed by the fixture 104 such as a screw. Then, by removing the fixture 260 such as a screw fixing the second crystal holder 210 to the main body 252, the second crystal holder 210 and the main body 252 are separated. Then, when the main body 252 is lifted, a wire 234 folded compactly is extended. While the second connecting terminal (upper side in the figure) of the heat-resistant male connector with two connecting terminals 228 and the heat-resistant female connector 236 connected to the second temperature control unit 232 are connected, the heat-resistant female connector 136 connected to the first temperature control unit 132 is connected to the first connecting terminal (lower side in the figure) of the heat-resistant male connector with two connecting terminals 228.

Then, while the two female connectors are connected to the heat-resistant male connector with two connecting terminals 228, the supply of power to the second heater 216 is switched from the second power supply system 230 having the second temperature control unit 232 to the first power supply system 130 having the first temperature control unit 132 by operating the change over switch belonging to the heat-resistant male connector with two connecting terminals 228. The power supply source to the second heater 216 is thereby switched continuously. In this manner, the nonlinear crystal for replacement 214 is mounted on the wavelength converter 100 while maintaining the nonlinear crystal for replacement 214 at a predetermined temperature by reducing a temperature drop of the nonlinear crystal for replacement 214 to zero infinitely.

Then, after checking that temperature control by the first power supply system 130 is working normally, the heat-resistant female connector 236 connected to the second temperature control unit 232 is separated from the heat-resistant male connector with two connecting terminals 228. The main body 252 of the crystal storage apparatus is thereby completely separated from the wavelength converter 100. Then, a laser light whose wavelength is converted can be obtained by irradiating the nonlinear crystal for replacement 214 with a laser light from a laser light source.

According to the wavelength converter system and the crystal replacement method using thereof as described above, the temperature rise time to heat a nonlinear crystal to a predetermined temperature during crystal replacement can further be reduced when compared with the first embodiment because switching of the power supply system is easy and requires a shorter time. Therefore, in addition to the operation effect of the first embodiment, an operation effect of being able to further reduce the down time of a wavelength converter caused during maintenance of an apparatus is achieved.

### Third Embodiment

A wavelength converter system according to the third embodiment of the present invention is basically the same as that in the first embodiment except that the first crystal holder and the second crystal holder are constructed to be interchangeable including a container and thus, duplicate descriptions will be omitted. A wavelength converter system according to the present embodiment is effective particularly when a nonlinear crystal having a deliquescent property is used.

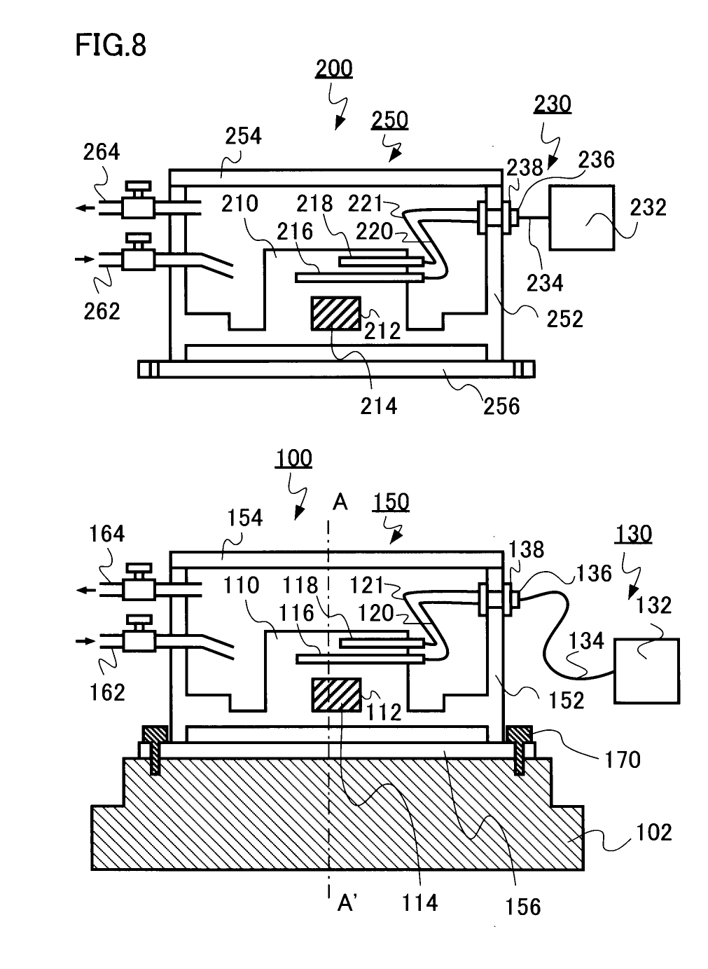

FIG. 8 is a sectional view of a wavelength converter system according to the present embodiment. The wavelength converter system is the same as that in the first embodiment in that the wavelength converter system includes the wavelength converter 100 and the crystal storage apparatus 200. Then, the first crystal holder 110 of the wavelength converter 100 and the second crystal holder 210 of the crystal storage apparatus 200 are constructed to be interchangeable including containers 150 and 250 respectively. Moreover, the containers 150 and 250 are detachable/attachable from/to the substrate 102 of the wavelength converter 100 using a fixture 170 such as a screw.

Here, in contrast to the first embodiment, the crystal holders 110 and 210 are integrated with a main body 152 and the main body 252 of the containers 150 and 250 respectively. The heat-resistant wires 120 and 212, and 220 and 221 from the heaters 116 and 216 and the temperature monitors 118 and 218 are connected to the heat-resistant female connector 136 and 236 of the power supply systems 130 and 230 by a airtight connector 138 and the airtight connector 238 respectively.

Next, a crystal replacement method using a wavelength converter in the present embodiment will briefly be described with reference to FIG. 8. First, the nonlinear crystal for replacement 214, which is the same type as the nonlinear crystal 114, is fixed to the crystal installation portion 212 of the second crystal holder 210 in the crystal storage apparatus 200 before the nonlinear crystal 114 used in the wavelength converter 100 becomes unusable due to degradation, which is the same as the method in the first embodiment.

Then, if a crystal having a deliquescent property is used as the nonlinear crystal for replacement 214, the nonlinear crystal for replacement 214 is fixed and adjusted while blowing a gas for drying such as a nitrogen gas to the nonlinear crystal for replacement 214 from the gas inlet 262. This is because degradation of the nonlinear crystal for replacement 214 being fixed and adjusted can thereby be suppressed.

Next, after fixing of the nonlinear crystal for replacement 214 to the second crystal holder 210 and adjustments thereof are completed, the nonlinear crystal for replacement 214 is heated in advance by an electrothermal heater, which is the second heater 216, and the temperature monitor 218 to a predetermined temperature in the crystal storage apparatus 200. If the nonlinear crystal for replacement 214 has a deliquescent property, a gas for drying such as a nitrogen gas is always introduced from the gas inlet 262 and also air is exhausted from the gas outlet 264 to prevent degradation of the nonlinear crystal for replacement 214 by maintaining moisture content in the atmosphere inside the container 250 at a low level.

Next, if the nonlinear crystal 114 used in the wavelength converter 100 degrades and replacement thereof is needed, incidence of the laser light is first stopped. Then, the heat-resistant female connector 136 connected to the first temperature control unit 132 and the airtight connector 138 connected to the first heater 116 and the temperature monitor 118 are separated. Then, the first crystal holder 110 and the wavelength converter 100 are completely separated by removing the fixture 170 such as a screw fixing the container 150 having the first crystal holder 110 to the substrate 102 of the wavelength converter 100.

Next, a method of mounting the nonlinear crystal for replacement 214 stored in the crystal storage apparatus 200 on the wavelength converter 100 will be described.

First, the crystal storage apparatus 200 is moved close to the wavelength converter 100 while maintaining the nonlinear crystal for replacement 214 at a predetermined temperature. Then, valves of the gas inlet 262 and the gas outlet 264 are closed to maintain a dry gas atmosphere inside of the container 250 and then, a pipe (not shown) to feed a dry gas to the crystal storage apparatus is removed. Degradation of the nonlinear crystal for replacement 214 due to exposure to the air can be suppressed by airtightly maintaining a dry gas atmosphere inside of the container 250.

Next, the container 250 is placed on the substrate 102 of the wavelength converter 100, and the second crystal holder 210 and the substrate 102 are fixed by the fixture 170 such as a screw. Then, the airtight connector 238 is separated from the heat-resistant female connector 236 and immediately connected to the heat-resistant female connector 136 connected to the first temperature control unit 132. Accordingly, heating by the second heater 216 is continued so that a temperature of the nonlinear crystal for replacement 214 is maintained at a predetermined temperature.

Here, particularly if the nonlinear crystal for replacement 214 has a deliquescent property, a pipe (not shown) for feeding/discharging a dry gas to/from the wavelength converter 100 is connected to the gas inlet 262 and the gas outlet 264 of the container 250 mounted on the substrate 102. Then, feeding and discharge of a gas is started by opening the valves of the gas inlet 262 and the gas outlet 264 after connecting the pipe.

Incidentally, the position of the nonlinear crystal for replacement 214 with respect to the second crystal holder 210 has been adjusted so as to be same as a spatial relationship between the first crystal holder 110 and the nonlinear crystal 114. Moreover, as described above, the nonlinear crystal for replacement 214 is heated and maintained at a working temperature. Thus, a laser light whose wavelength is converted can be obtained by irradiating the nonlinear crystal for replacement 214 with a laser light from a laser light source, which is the same as the first embodiment.

According to the present embodiment, as described above, a nonlinear crystal for replacement can be maintained in a dry gas atmosphere without being exposed to the air when replacing a nonlinear crystal. Thus, in addition to the operation effect of the first embodiment, an operation effect of being able to suppress degradation of a crystal resulting from crystal replacement work particularly when the nonlinear crystal for replacement has a deliquescent property is achieved.

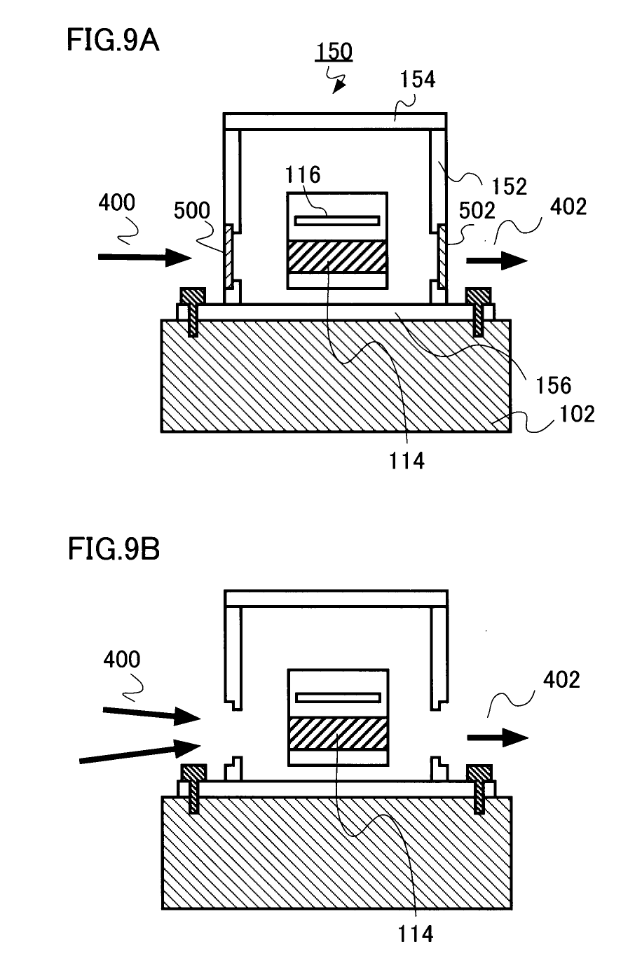

FIG. 9 is an A-A′ sectional view of the wavelength converter 100 in FIG. 8. In the present embodiment, the nonlinear crystal 114 inside the crystal holder 110 is replaced together with the airtight container 150. Therefore, as shown in FIG. 9, an optical window 500 through which an input light 400 into the nonlinear crystal 114 passes is provided in the main body 152. Also, an optical window 502 through which an output light 402 from the nonlinear crystal 114 passes is provided in the main body 152. These optical windows are formed of a material transparent to a laser light such as quartz glass and calcium fluoride.

Though transparent to the laser light, some energy loss occurs when passing through the optical windows. Also a problem of optical path shifts caused by refraction of the optical windows may arise. Thus, as shown in FIG. 9B, the optical windows may be configured to be detachable. Such a configuration is suitable, particularly as shown in FIG. 9B, when it is necessary to cause an input light to be incident at a certain angle with respect to the optical window (or a container wall surface). This is because optical path shifts resulting from refraction become pronounced when a laser light is incident obliquely. If, as shown in FIG. 9B, the optical windows are detachable, it is preferable to adopt a method by which, when a crystal is replaced, the optical windows are detached after a crystal storage apparatus is fixed to a substrate of a wavelength converter and introduction of a dry gas is started.

Embodiments of the present invention have been described above with reference to concrete examples. The above embodiments are shown only as examples and do not limit the present invention. Though components that are not directly needed for description of the present invention when describing a wavelength converter system, a crystal storage apparatus, a crystal replacement method of a wavelength converter and the like are omitted in the descriptions of embodiments, necessary elements involved in the wavelength converter system, the crystal storage apparatus, or the crystal replacement method of a wavelength converter may appropriately be selected and used. For example, the shape of a crystal holder or container, the type and position of a fixture such as a screw, the type and position of a heater and temperature sensor, and the type of a connector are not limited to those described in the above embodiments. The method of replacing a crystal and the procedure for replacing a crystal are not limited to those described in the above embodiments.

Regarding the nonlinear crystal (nonlinear optical crystal), mainly the LBO crystal has been taken as an example. However, the present invention is not limited to use of the LBO crystal and is applicable, for example, to other nonlinear optical crystals such as a CLBO crystal and BBO crystal. Moreover, the laser light incident on a nonlinear crystal is not limited to an Nd-YAG laser light and is applicable to other laser lights such as an Nd-YLF laser light and Ti:Al₂O₃ (titanium sapphire) laser light.

In addition, all wavelength converter systems, crystal storage apparatuses, and crystal replacement methods of a crystal converter that have elements of the present invention and whose design can appropriately be modified by a person skilled in the art are included in the scope of the present invention. The scope of the present invention is defined by claims and equivalents thereof.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wavelength converter system having a wavelength converter for converting a wavelength by passing light through a nonlinear crystal and a crystal storage apparatus for storing a nonlinear crystal for replacement used by the wavelength converter, wherein
the wavelength converter, comprising:
a first crystal holder for fixing the nonlinear crystal; and
a first heater mounted on the first crystal holder to heat the nonlinear crystal, and
the crystal storage apparatus, comprising:
a container;
a second crystal holder provided inside the container to fix the nonlinear crystal for replacement and interchangeable with the first crystal holder; and
a second heater mounted on the second crystal holder to heat the nonlinear crystal for replacement.

2. The system according to claim 1, wherein the container has a gas inlet and a gas outlet to fill the container with at least one kind of gas.

3. The system according to claim 1, wherein the wavelength converter has a first power supply system to the first heater,
the crystal storage apparatus has a second power supply system to the second heater, and
the crystal storage apparatus has a mechanism to continuously switch a power supply source to the second heater from the second power supply system to the first power supply system.

4. The system according to claim 2, further comprising a gas blowing device for blowing the gas to the nonlinear crystal for replacement from the gas inlet when interchanging the first crystal holder and the second crystal holder.

5. The system according to claim 1, wherein the first crystal holder and the second crystal holder are constructed to be interchangeable including the container.

6. The system according to claim 2, wherein the first crystal holder and the second crystal holder are constructed to be interchangeable including the container.

7. The system according to claim 5, wherein the container has optical windows transparent to the light.

8. The system according to claim 7, wherein the optical windows are detachable.

9. A crystal storage apparatus for storing a nonlinear crystal for replacement used by a wavelength converter for converting a wavelength by passing light through a nonlinear crystal, comprising:
a container;
a crystal holder provided inside the container to fix the nonlinear crystal for replacement and mountable on the wavelength converter; and
a heater mounted on the crystal holder to heat the nonlinear crystal for replacement.

10. The apparatus according to claim 9, wherein the container has a gas inlet and a gas outlet to fill the container with at least one gas.

11. The apparatus according to claim 9, wherein the container has optical windows transparent to the light.

12. The apparatus according to claim 11, wherein the optical windows are detachable.

13. A crystal replacement method of a wavelength converter using a crystal storage apparatus for storing a nonlinear crystal for replacement used by the wavelength converter, comprising:
heating the nonlinear crystal for replacement to a predetermined temperature in advance by the crystal storage apparatus;
removing a nonlinear crystal to be replaced in the wavelength converter; and
mounting the nonlinear crystal for replacement on the wavelength converter while maintaining approximately the predetermined temperature.

14. The method according to claim 13, wherein the nonlinear crystal for replacement is kept in a dry gas atmosphere when heating the nonlinear crystal for replacement to the predetermined temperature in advance.

15. The method according to claim 13, wherein a dry gas is to the nonlinear crystal for replacement when mounting the nonlinear crystal for replacement on the wavelength converter.

16. The method according to claim 14, wherein the nonlinear crystal for replacement is kept in a dry gas atmosphere when mounting the nonlinear crystal for replacement on the wavelength converter.

17. A crystal replacement method of a wavelength converter using a crystal storage apparatus for storing a nonlinear crystal for replacement used by the wavelength converter, comprising:
maintaining a nonlinear crystal fixed to a first crystal holder of the wavelength converter at a predetermined temperature by supplying power to a first heater mounted on the first crystal holder from a first power supply system;
maintaining a nonlinear crystal for replacement fixed to a second crystal holder of the crystal storage apparatus at the predetermined temperature by supplying power to a second heater mounted on the second crystal holder from a second power supply system;
removing the first crystal holder of the wavelength converter from the wavelength converter;
mounting the second crystal holder on the wavelength converter in place of the first crystal holder while power from the second power supply system to the second heater is being supplied; and
switching a power supply source to the second heater from the second power supply system to the first power supply system.

18. The method according to claim 17, wherein the nonlinear crystal for replacement is kept in a dry gas atmosphere when the nonlinear crystal for replacement is maintained at the predetermined temperature.

19. The method according to claim 17, wherein the nonlinear crystal for replacement is kept in a dry gas atmosphere when mounting the second crystal holder on the wavelength converter.

20. The method according to claim 17, wherein a dry gas is fed to the nonlinear crystal for replacement when mounting the second crystal holder on the wavelength converter.
